(19) United States
(12) Patent Application Publication
(10) Pub. No.: US 2011/0296070 A1
(43) Pub. Date: Dec. 1, 2011

(54) MOTHERBOARD AND COMPUTER USING SAME

(75) Inventors: FU-CHIAO SHIH, Tu-Cheng (TW); TSUNG-KUEL LIAO, Tu-Cheng (TW); TE-CHUNG KUAN, Tu-Cheng (TW)

(73) Assignee: HON HAI PRECISION INDUSTRY CO., LTD., Tu-Cheng (TW)

(21) Appl. No.: 12/853,574

(22) Filed: Aug. 10, 2010

(30) Foreign Application Priority Data
Jun. 1, 2010 (TW) 99117500

(51) Int. Cl. G06F 13/00

(52) U.S. Cl. 710/300

(57) ABSTRACT

A motherboard includes a main board, a CPU seat, and at least one CPU expansion interface. The first CPU seat is seated on the main board. The at least one CPU expansion interface is formed on the main board abutting the first CPU seat for providing an expansion accessing terminal to add another CPU to the motherboard.

### BACKGROUND

1. Technical Field

The disclosure relates to motherboards, particularly to a motherboard with a CPU expansion seat and a computer using the same.

2. Description of Related Art

With the increasing requirement of the operational speed of personal computers or servers, new generations of CPUs are regularly developed. However motherboards are only able to accommodate one CPU, as a result, the old CPU will be replaced by the new CPU for improving the operational capability of computers or servers, and the old one discarded, which is wasteful and environmentally unfriendly.

Therefore it is desirable to provide a new motherboard and a computer using the same which can overcome the above-mentioned limitations.

### BRIEF DESCRIPTION OF THE DRAWINGS

FIG. 1 is an isometric exploded view of a motherboard and an expansion circuit board in accordance with an exemplary embodiment.

FIG. 2 is an assembled view of the motherboard and the expansion circuit board of FIG. 1.

### DETAILED DESCRIPTION

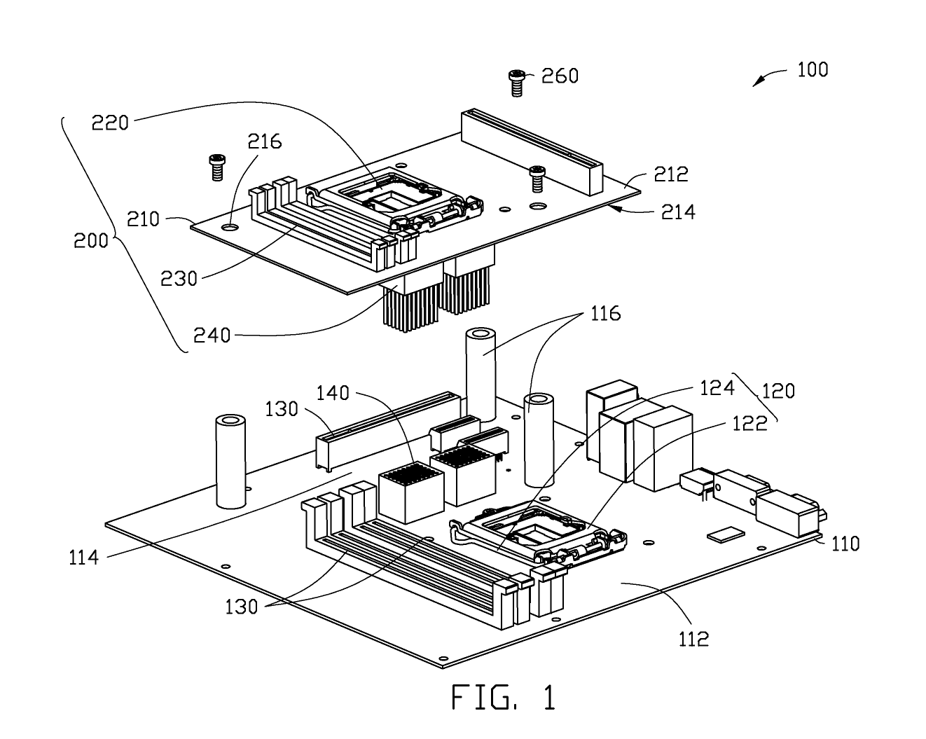

Referring to FIG. 1, a motherboard 100 and an expansion circuit board 200 in accordance with an exemplary embodiment are shown.

The motherboard 100 includes a main board 110, a first CPU seat 120, a number of expansion slots 130, and a number of CPU expansion interfaces 140. The first CPU seat 120 is seated on the main board 110 for holding a CPU thereon. The expansion slots 130 are distributed on the main board 110. The CPU expansion interface 140 is formed on the main board 110 adjacent to the first CPU seat 120 for providing an expansion accessing terminal for electrically connecting an additional circuit board such as the expansion circuit board 200 with an another CPU.

The main board 100 is used for holding various of electronic elements and electrically connecting those elements to each other by conductive traces formed thereon. The main board 100 includes a first CPU support area 112 for receiving the first CPU seat 120, and a second support area 114 abutting against the first CPU support area 112 for receiving the CPU expansion interfaces 140. The second support area 114 has a number of electronic elements distributed therein, a number of conductive traces interconnecting with the electronic elements, and a number of fixing poles 116 perpendicularly extending from a top surface of the second support area 114 for fixing the expansion circuit board 200.

The first CPU seat 120 includes a CPU holder 122, which holds and electrically connects to the CPU, and a fastener 124 for fixing the CPU on the CPU holder 122.

The expansion slots 130 are arranged on the main board 110 beside the first CPU support area 112 and the second support area 114 for receiving expansion cards such as, RAM, display adapter, net adapter and so on.

The CPU expansion interface 140 abuts against the first CPU seat 120, and includes a quick path interconnect and any other necessary communicational interfaces for providing communication between the CPU and other associated elements.

The expansion circuit board 200 includes a substrate 210, a second CPU seat 220, a number of sub-expansion slots 230, a number of signal output terminals 240, and a number of fixing members 260. The second CPU seat 220 is set on the substrate 210, and the sub-expansion slots 230 are distributed at a side of the CPU seat 220.

The substrate 210 supports a number of electronic elements thereon, and includes a first surface 212 and a second surface 214 opposite to the first surface 212. The electronic elements are electrically connected to each other by the electrically conductive traces that are formed on the first surface 212 of the substrate 210. The substrate 210 defines a number of threaded holes 216 aligned with the fixing poles 116 of the main board 110 for the fixing members 260 screwing therein and fixing the substrate 210 on the fixing poles 116.

The configuration of the second CPU seat 220 is similar to that of the first CPU seat 120 and set on the center of the first surface 212 of the substrate 210.

The signal output terminals 240 are fixed on the second surface 214 of the substrate 210, and communicated to the second CPU seat 220 and the sub-expansion slots 230.

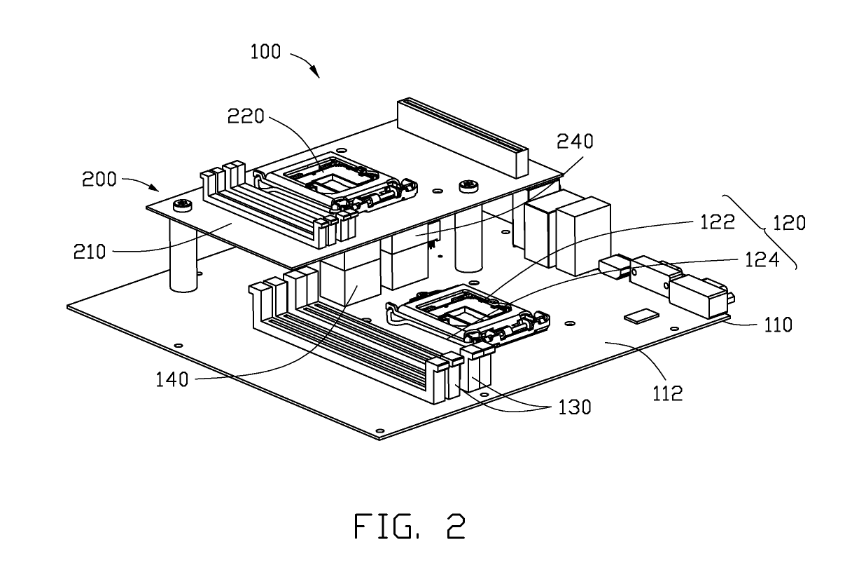

Referring to FIG. 2, in use, each signal outputting terminal 240 is directly plugged into a corresponding CPU expansion interface 140 for establishing communication between the expansion circuit board 200 and the motherboard 100. Then, the fixing members 260 are extended through the threaded holes 216 and received in the fixing poles 116 to fix the motherboard 110 on the fixing poles 116 over the second support area 114.

Unlike a conventional motherboard, the motherboard 100 of the present disclosure includes a CPU expansion interface 140 at the second support area 114, thereby providing convenience for users as needed to install an additional CPU to the motherboard 100. In addition, the expansion circuit board 200 overlaps the motherboard 100 which can improve the efficiency of space utilization to keep size of the motherboard 100 minimized as well improve the performance.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A motherboard comprising:
a main board;
a CPU seat seated on the main board; and
at least one CPU expansion interface located on the main board abutting the CPU seat for providing an expansion accessing terminal to add another CPU for the motherboard.

2. The motherboard of claim 1, wherein the main board comprises a first CPU support area where the CPU seat is seated, and a second support area where the at least one CPU expansion interface is located.

3. The motherboard of claim 2, wherein the second support area comprises a plurality of fixing poles perpendicularly extending from the second support area for fixing an expansion circuit board.

4. The motherboard of claim 3, further comprising a plurality of expansion slots arranged on the main board beside the first CPU support area and the second support area.

5. A computer comprising:
a motherboard comprising:
a main board;
a first CPU seat positioned on the main board; and
a plurality of CPU expansion interfaces located on the main board; and
an expansion circuit board comprising:
a substrate,
a second CPU seat positioned on a first surface of the substrate; and
a plurality of signal outputting terminals positioned on a second surface of the substrate and connected to the second CPU seat, each of the signal outputting terminals being plugged into a corresponding CPU expansion interface to establish communication between the motherboard and the expansion circuit board.

6. The computer of claim 5, wherein the main board comprises a first CPU support area where the first CPU seat is seated, and a second support area where the CPU expansion interfaces are located.

7. The computer of claim 6, wherein the motherboard comprises a plurality of expansion slots arranged on the main board beside the first CPU support area and the second support area.

8. The computer of claim 6, wherein the expansion circuit board overlaps the second support area of main board.

9. The computer of claim 6, further comprising a plurality of fixing members; wherein the substrate defines a plurality of threaded holes, the main board defines a plurality of fixing poles perpendicularly extending from the second support area, and the fixing members are extended through the threaded holes and received in the fixing poles.

10. The computer of claim 5, wherein the expansion circuit board further comprises a plurality of sub-expansion slots distributed on the substrate and connected to the signal outputting terminals.
